(19) United States
(12) Patent Application Publication
(10) Pub. No.: US 2016/0154644 A1
(43) Pub. Date: Jun. 2, 2016

(54) REAL-TIME PREVIEWING AND MODIFYING AN APPLICATION UNDER DEVELOPMENT

(71) Applicant: Ram Chhawchharia, Ahmadabad (IN)

(72) Inventor: Ram Chhawchharia, Ahmadabad (IN)

(21) Appl. No.: 14/841,695

(22) Filed: Aug. 31, 2015

Related U.S. Application Data
(60) Provisional application No. 62/044,132, filed on Aug. 29, 2014.

(51) Int. Cl. G06F 9/44

(52) U.S. Cl. CPC G06F 8/71; G06F 8/30

(57) ABSTRACT

A preview server system receives a first request to download an application under development. The preview server system transmits the device-specific executable of the application to the user communication device. The preview server system may then receive configuration changes from either the same user communication device or a second user communication device. The preview server system updates the module associated with the configuration changes and regenerates the device-specific executable of the application by compiling only the relevant module in the device-specific executable of the application.

### CLAIM OF PRIORITY

The present invention claims priority from and is a non-provisional of U.S. Provisional Application No. 62,044,132 entitled “Real-Time App Previewing and Flow Chart Driven API Visual Configuration” Filed Aug. 29, 2014, the entirety of which is incorporated by reference as if fully set forth herein.

### BACKGROUND OF THE INVENTION

An owner (also referred to herein as a client) of a software application (also referred to simply as an app) typically hires a software developer to create the app for use on a particular mobile platform. For instance, the client may hire the developer to develop an app for use on a mobile device operating on the iOS platform or the Android platform.

In order for the client to preview the app during development of the app, the developer may send a link or other access to the client to enable the client to download the app on a mobile device. Subsequent to previewing the app, if the client wants to modify the app, the client may inform the developer of changes to the app, for example, by sending an email message to the developer.

The developer may thereafter incorporate the client's changes into the source code of the app and recompile the entire source code of the app. The developer may then send a link or other access to the updated app to the client. In order for the client to preview the updated app, the client may have to uninstall any previous versions of the app on the mobile device and then install the updated app on the mobile device. If the client wants to make further changes, the process above is repeated.

A developer may be employed to work on multiple apps. Each app may require access to information stored in one or more databases and the developer may be employed to provide Application Programming Interfaces (APIs) for multiple databases, wherein each app may use one or more APIs to retrieve or store information in one or more databases. Depending on the number of database tables associated with apps under development, it may take the developer a relatively long time to develop source code for each app.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of an apparatus and method for real-time previewing and modifying of an application under development can be found in exemplary embodiments of the present invention.

An embodiment of the present invention uses a preview server system to receive from a communication device, a first request to download an application under development. The preview server system retrieves configuration data associated with the application under development and generates, with the configuration data, a device-specific executable of the application.

The preview server system then transmits the device-specific executable of the application to the user communication device. The preview server system may then receive configuration changes from either the same user communication device or a second user communication device. The configuration changes may be desired changes associated with one of a plurality of modules in the device-specific executable of the application.

The preview server system updates the module associated with the configuration changes and regenerates the device-specific executable of the application by compiling only the relevant module in the device-specific executable of the application.

The preview server system may then receive a second request to transmit a regenerated version of the application including the configuration changes. In response to receiving the second request, the preview server system transmits to the user communication device and/or a second user communication device, the regenerated version of the application so that the desired changes are reflected contemporaneously on the communication device(s). In this manner, mobile applications under development may be viewed relatively quickly in real-time with full native behavior by compiling and generating build. In one aspect, instant updates or refresh changes on a specific screen of mobile application can be accomplished without navigating away from the screen.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 is a block diagram of an app preview system used in accordance with some embodiments.

FIG. 2 is a block diagram of a preview server system used in accordance with some embodiments.

FIG. 3 is a block diagram of a user communication device used in accordance with some embodiments.

FIG. 4 is a flow diagram of a method implemented on a preview component on a user communication device in accordance with some embodiments.

FIG. 5 is a flow diagram of a method implemented on a preview server system in accordance with some embodiments.

FIG. 6 is a block diagram of a visual application development system used in accordance with some embodiments.

FIG. 7 is a block diagram of an app preview system used in accordance with some embodiments.

### DETAILED DESCRIPTION OF THE INVENTION

Reference will now be made in detail to the embodiments of the invention, examples of which are illustrated in the accompanying drawings. While the invention will be described in conjunction with the one embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

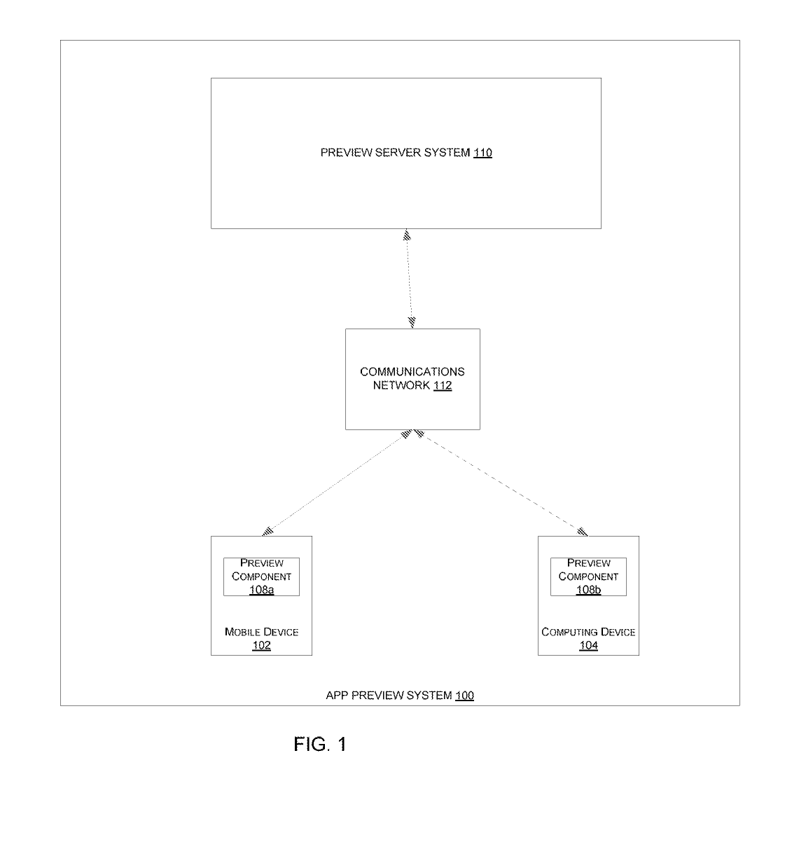

FIG. 1 is a block diagram of an app preview system in accordance with an exemplary embodiment of the present invention.

In FIG. 1, app preview system 100 includes user communication devices (shown, for example, as a mobile device 102 and a computing device 104). Although not shown, other communication devices may be employed with app preview system 100.

Mobile device 102 may be, for example a mobile phone or a tablet operating under a specific platform, for example, operating under the iOS or Android platform. Computing device 104 may be, for example, a laptop, a desktop computer or a tablet operating on the same or a different platform than mobile device 102.

Each of the user communication devices, i.e., mobile device 102 and computing device 104, may include a preview component 108 (i.e., preview component 108a and 108b) that permits viewing, in real-time, of one or more apps under development. The preview components themselves can display an index of apps under development, from which the user can select a specific app to preview.

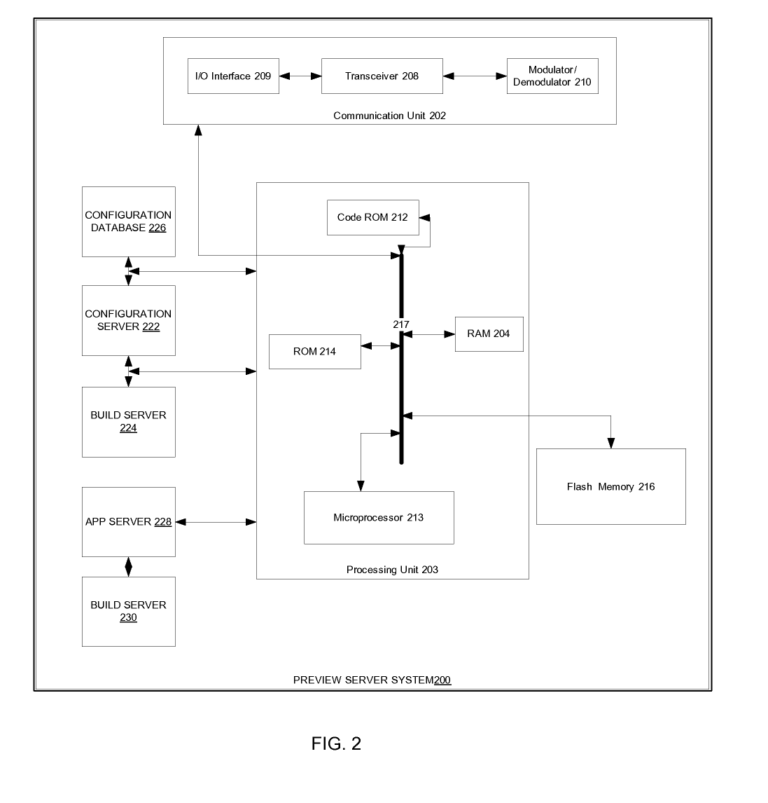

In one implementation, the user can select the app to preview—for which two options are provided. Either user can request a fresh build from the configuration server 222 (FIG. 2) or can use the last build that was downloaded earlier. All of the builds that user requests are stored on the user's mobile device to avoid future downloading.

App preview system 100 also includes a preview server system 110 which may be configured as a development platform for developing apps. As such, a developer may develop one or more apps on preview server system 110. Each of the user communication devices, i.e., mobile device 102 and computing device 104, may be communicatively coupled with preview server system 100 via a wired or wireless communications network 112, such as the Internet.

During development of an app, a request to preview the app may be transmitted from one or both of user communication devices 102 and 104 to preview server system 110. Depending on the user's preferences, the preview request may be from computing device 104, mobile device 102 or both.

In response to the first request(s), preview server system 110 may transmit the app under development to the requesting user communication devices 102 and/or 104 via communication network 112. Subsequent to the app being received by user communication devices 102 and/or 104, preview component 108 on each user communication device 102 and 104 may be executed to display the app.

Consider an example, where the request is sent from communication device 102 and 104 and the app is displayed on user communication devices 102 and 104. If the user wants to modify the app, the user may submit changes to the app from computing device 104 to preview server system 110. Unlike conventional systems, the user need not uninstall previous versions of the app on mobile device 102 to preview the changes in real-time.

Once changes are made on computing device 104, the changes are reflected contemporaneously and generally in real time on mobile device 102. In this manner, mobile applications under development may be viewed relatively quickly in real-time with full native behavior by compiling and generating build. Instant updates or refresh changes on specific screen of mobile application can be accomplished without navigating away from the screen.

FIG. 2 is a block diagram of a preview server system 200 such as preview server system 110 of FIG. 1 in accordance with an exemplary embodiment of the present invention.

In FIG. 2, preview server system 200 may include a configuration server 222, a build server 224, a configuration database 226, an app data server 228, and an app database 230. Although not shown, configuration server 222, build server 224, configuration database 226, app data server 228, and/or app database 230 may be included within processing unit 203.

Configuration database 226 and/or app database 230 may be stored on one or more of ROM 214, RAM 204 and flash memory 216 and/or on an external memory device (not shown). Configuration database 226 and/or app database 230 may store source code and configuration data for a plurality of applications.

Configuration server 222 retrieves mobile app configurations from configuration database 226 for association with mobile apps source code for mobile apps under development. Subsequent to receiving a preview request for an app under development from one or both of user communication devices 102 and 104 of FIG. 1, configuration server 222 may retrieve pertinent configuration data for the app from configuration database 226.

Configuration server 222 may then forward the configuration data along with the mobile app source code to build server 224. Build server 224 may use a set of tools and software development kits (SDKs) to compile the mobile app source code based on the configuration to generate a device-specific executable of the requested application under development. Preview server system 200 may then transmit the device-specific executable of the application to the requesting user communication devices 102 and/or 104.

In FIG. 2, preview server system 200, for example, may include a communications unit 202 coupled to a common data and address bus 217 of a processing unit 203. The processing unit 203 may include a code read-only memory (ROM) 212 for storing data for initializing system components of preview server system 200. The processing unit 203 may further include a microprocessor 213 coupled, by common data and address bus 217, to one or more memory devices, such as a read only memory (ROM) 214, a random access memory (RAM) 204, and/or a static memory 216. One or more of ROM 214, RAM 204 and flash memory 216 may be included as part of processing unit 203 or may be separate from, and coupled to, the processing unit 203. Communications unit 202 may include a wired or wireless input/output I/O interface 209 configurable to communicate with network components within its communication range. Communications unit 202 may include one or more broadband and/or narrowband transceivers 208, a wireless transceiver perhaps operating in accordance with an IEEE 802.16 standard, and/or other similar type of wireless transceiver configurable to communicate via a wireless network for infrastructure communications. Communications unit 202 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 210.

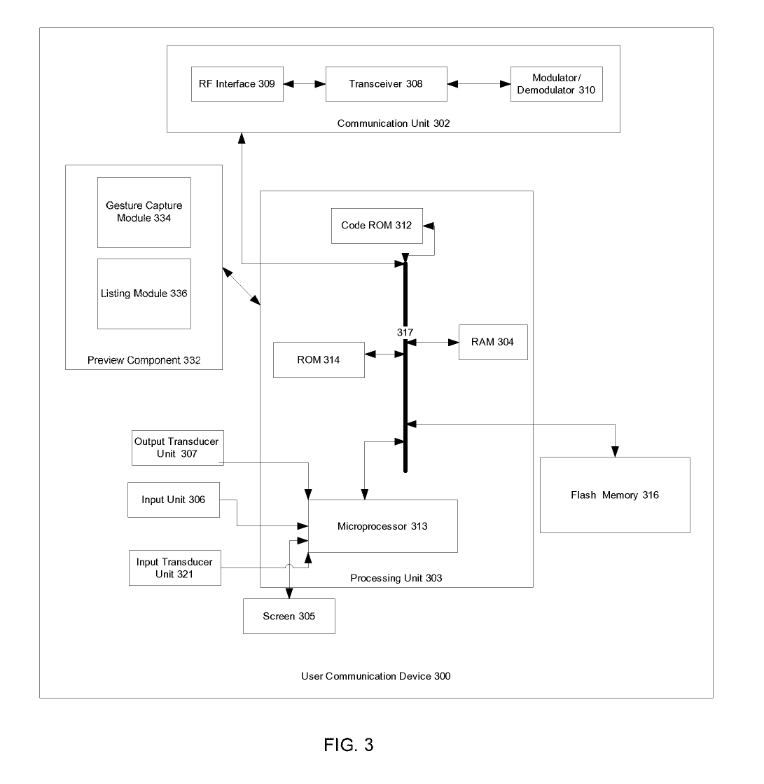

FIG. 3 is a block diagram of a user communication device 300, such as user communication devices 102 and 104 of FIG. 1 in accordance with an exemplary embodiment of the present invention.

In FIG. 3, user communication device 300 may include a preview component 332, such as preview component 108 of FIG. 1, which is configured to execute a device-specific executable of an application. By device-specific, it is meant that the executable is native to the mobile communication device, that is, the executable is compiled into the machine language of that CPU and is coded in a specific programming language, such as Objective C for iOS and Java for Android operating systems. Thus, the native app of the present invention provides runs fast, has increased performance and a high degree of reliability unlike a Web-based application that is stored on a server and interpreted one line at a time by the browser's JavaScript or HTML5 interpreter.

Preview component 332 may include a gesture capture module 334 which may be configured to detect user gestures on display screen 305 and request a device-specific executable (or build) of an application from configuration server 222.

Preview component 332 may also include a listing module 336 which is configured to list a plurality of applications under development on display screen 305. Accordingly, when a device-specific executable of an application is received from preview server system 200, preview component 332 executes the received application and user communication device 300 displays the output of the application on display screen 305. User communication device 300 may also retrieve data required to run the application from app database 230 via app data server 228.

Consider an example referred herein as delta compilation involving refreshing a specific screen on mobile device 102 while it is running the preview application. The user may use a browser for example to modify the app displayed on computing device 104. Note that in one embodiment, the browser configuration may be stored on configuration server 222. The user enters configuration changes via computing device 104.

After receipt of the changes, configuration server 222 may implement the changes and store the changes on configuration database 226. These changes can be instantly viewed on the preview application for a specific screen. While using the preview app to view a mobile app, the user with a help of specific gesture can update the screen.

The user does this without navigating back or explicitly requesting full compilation and the build of the mobile application from the build server. The Preview Application immediately reflects the changes in Application Screen Design and Data Elements—by requesting the compilation and a build for the said specific screen instead of entire mobile application.

Specifically, in an embodiment, an application may include one or more modules, wherein each module corresponds to a set of source code that can be compiled independently of other modules in the application. As such, configuration changes to one module may be implemented (i.e., the corresponding source code may be modified and compiled) independently of other modules in the application and without the requirement of compiling the source code for all modules of the application to incorporate the changes to one or more modules of the application.

Consider an example where the user wishes to modify one or more screen data elements of an app. In such an example, the user may supply only configuration changes for the screen data elements that are to be modified to preview server system 200 via user communication device 104.

Subsequent to receiving the configuration changes from user communication device 104, preview server system 200 may compile only the source code for the specific modules of the device-specific executable of the application that are associated with the configuration changes when regenerating the application (i.e., when generating a new version of the application).

In particular, in a regenerated application/new version of the application, build server 224 may generate new source code for only those modules associated with the screen data elements modified by the user. Configuration server 222 may store the changes on configuration database 226.

While the user is editing the app on computing device 104, configuration server 222 may receive a second request to transmit a new/regenerated version of the app with the changes entered into computing device 104 to user communication devices 102 and/or 104.

Configuration server 222 may forward the new version of the app to user communication devices 102 and/or 104, wherein when the new version of the app is received on mobile device 102, preview component 332 of mobile device 102 immediately provides access to the changes entered in computing device 104. Accordingly, the changes made on computing device 104 are contemporaneously observable on preview component 332 of mobile device 102.

In FIG. 3, user communication device 300, for example, may also include a communications unit 302 coupled to a common data and address bus 317 of a processing unit 303. User communication device 300 may also include an input unit (e.g., keypad, pointing device, etc.) 306, an output transducer unit (e.g., speaker) 30U7, an input transducer unit (e.g., a microphone) (MIC) 321, and a display screen 305, each coupled to be in communication with the processing unit 303. The processing unit 303 may include a code read-only memory (ROM) 312 for storing data for initializing system components of user communication device 300. The processing unit 303 may further include a microprocessor 313 coupled, by the common data and address bus 317, to one or more memory devices, such as a read only memory (ROM) 314, a random access memory (RAM) 304, and/or a static memory 316. One or more of ROM 314, RAM 304 and flash memory 316 may be included as part of processing unit 303 or may be separate from, and coupled to, the processing unit 303. Communications unit 302 may include an RF interface 309 configurable to communicate with network components and other user equipment within its communication range. Communications unit 302 may include one or more broadband and/or narrowband transceivers 308, a WiMAX transceiver perhaps operating in accordance with an IEEE 802.16 standard, and/or other similar type of wireless transceiver configurable to communicate via a wireless network for infrastructure communications. Communications unit 302 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 310.

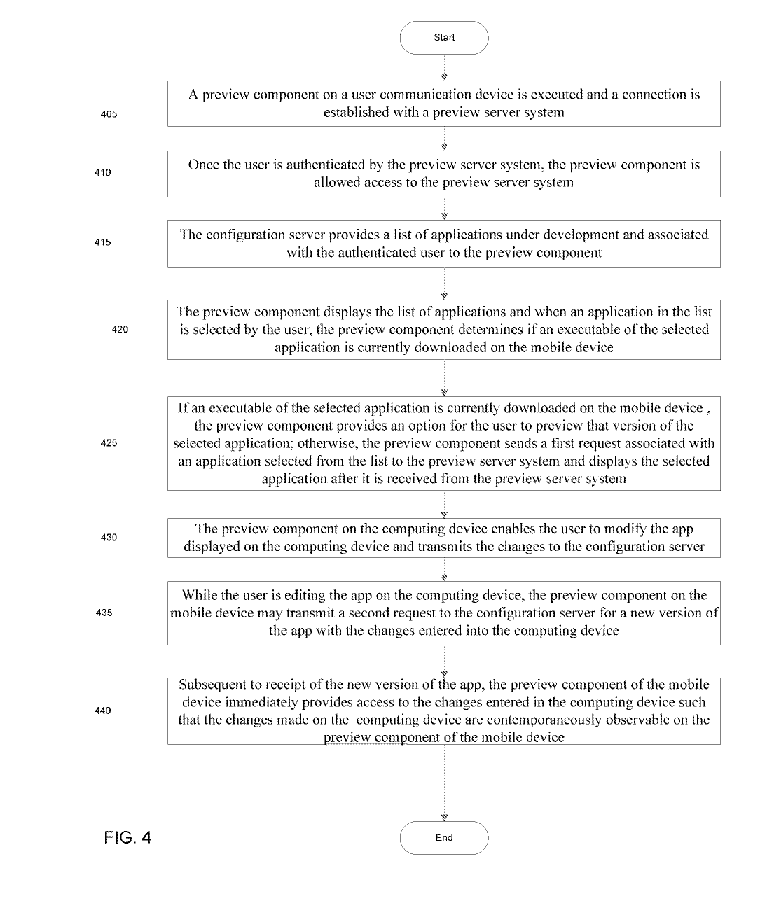

FIG. 4 is a flow diagram of a method 400 implemented in accordance with some embodiments.

In FIG. 4, memory devices 312, 314 and 316 are may store non-transitory computer-executable instructions to perform a set of functions such as one or more of the steps set forth in FIG. 4.

At 405, preview component 332 on a user communication device is executed and a connection is established with preview server system 200.

At 410, once the user is authenticated by preview server system 200, preview component 332 is allowed access to preview server system 200.

At 415, configuration server 222 provides a list of applications under development and associated with the authenticated user to preview component 332.

At 420, preview component 332 displays the list of applications and when an application in the list is selected by the user, preview component 332 determines if an executable of the selected application is currently downloaded on mobile device 102.

At 425, if an executable of the selected application is currently downloaded on mobile device 102, preview component 332 provides an option for the user to preview that version of the selected application; otherwise, preview component 332 sends a first request associated with an application selected from the list to preview server system 200 and displays the selected application after it is received from preview server system 200.

At 430, preview component 332 on computing device 104 enables the user to modify the app displayed on computing device 104 and transmits the changes to configuration server 222.

At 435, while the user is editing the app on computing device 104, preview component 332 on mobile device 102 may transmit a second request to configuration server 222 for a new version of the app with the changes entered into computing device 104. The second request may be generated based on information obtained via a gesture capture module.

At 440, subsequent to receipt of the new version of the app, preview component 332 of mobile device 102 immediately provides access to the changes entered in computing device 104 such that the changes made on computing device 104 are contemporaneously observable on preview component 332 of mobile device 102.

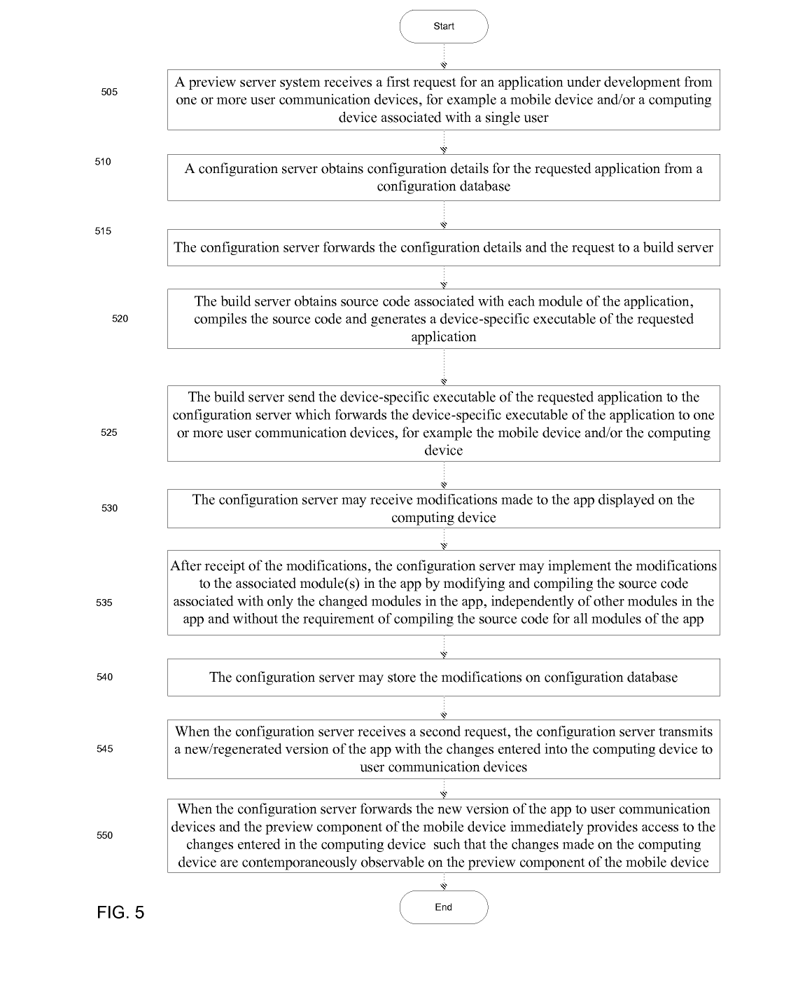

FIG. 5 is a flow diagram of a method 500 implemented in accordance with some embodiments.

In FIG. 5, memory devices 212, 214 and 216 are configured to store non-transitory computer-executable instructions to perform a set of functions such as one or more of the steps set forth in FIG. 5.

At 505, preview server system 200 receives a first request for an application under development from one or more user communication devices, for example mobile device 102 and/or computing device 104 associated with a single user.

At 510, configuration server 222 obtains configuration details for the requested application from configuration database 226.

At 515, configuration server 222 forwards the configuration details and the request to build server 224.

At 520, build server 224 obtains source code associated with each module of the application, compiles the source code and generates a device-specific executable of the requested application.

At 525, build server 224 send the device-specific executable of the requested application to configuration server 222 which forwards the device-specific executable of the application to one or more user communication devices, for example mobile device 102 and/or computing device 104.

At 530, configuration server 222 may receive modifications made to the app displayed on computing device 104.

At 535, after receipt of the modifications, configuration server 222 may implement the modifications to the associated module(s) in the app by modifying and compiling the source code associated with only the changed modules in the app, independently of other modules in the app and without the requirement of compiling the source code for all modules of the app.

At 540, configuration server 222 may store the modifications on configuration database 226.

Subsequent to modifying the app, at 545, when configuration server 222 receives a second request, configuration server 222 transmits a new/regenerated version of the app with the changes entered into computing device 104 to user communication devices 102 and 104.

At 550, configuration server 222 forwards the new version of the app to user communication devices 102 and 104, wherein preview component 332 of mobile device 102 immediately provides access to the changes entered in computing device 104 and the changes made on computing device 104 are contemporaneously observable on preview component 332 of mobile device 102 in accordance with exemplary embodiments.

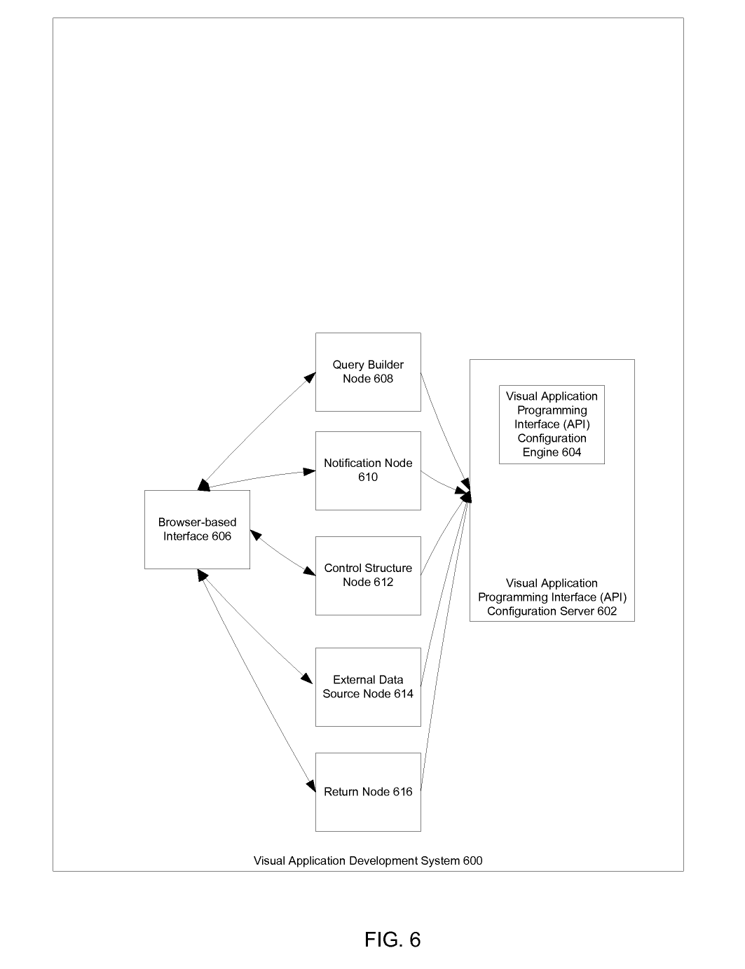

FIG. 6 is a block diagram of a visual application development system 600 used in accordance with some embodiments.

In FIG. 6, visual application development system 600 may be incorporated into or otherwise communicatively coupled to preview component 332 and preview component 108, as shown in FIG. 3 and FIG. 1. As such, visual application development system 600 may be may be included as part of processing unit 303 or may be separate from, and coupled to, the processing unit 303.

Visual application development system 600 may be incorporated into or otherwise communicatively coupled to one or more memory devices, such as a read only memory (ROM) 314, a random access memory (RAM) 304, and/or a static memory 316. The one or more memory devices 312, 314 and 316 are configured to store non-transitory computer-executable instructions to perform a set of functions. Visual application development system 600 may receive inputs from screen 305 and provide outputs to screen 305.

Visual application development system 600 includes a visual Application Programming Interface API configuration server 602 that further comprises a visual API engine 604. Visual API engine 604 uses user-specific configurations to generate API source code for associated modules of an application.

Using a browser-based interface 606 displayed on screen 305 on a user communication device, for example, computing device 104, a user may modify elements of an application being displayed on computing device 104. Based on user inputs received in browser-based interface 606, visual API engine 604 may generate source code based on configuration of one or more flow charts, without the user having to write a single line of source code.

In particular, browser-based interface 606 may receive user inputs via a plurality of nodes 608-616 or software modules, including a query builder node 608, a notification node 610, a control structure node 612, an external data source node 614 and a return node 616.

Based on the business logic of a client, one or more configuration flows may be implemented to generate code using one or more of the plurality of node 608-616. Each node 608-616 is configured to obtain specific user inputs that handle specific operations. Each node 608-616 is further configured to receive input values as parameters for each configuration flow in the business logic of a client may and nodes 608-616 may also generate values for final output(s). Using the generated inputs and outputs, visual API engine 604 may generate source code for APIs for at least one module of an application under development, wherein the API engine 604 can receive values as requests and can return outputs as responses

Each of the plurality of nodes 608-616 represents specific operations in an API coding scheme and may be configured to facilitate visual configuration within browser-based interface 606. For example, query builder node 608 may be used to generate queries for database tables based on specific user inputs.

Notification node 610 may be used to generate notifications based on specific user inputs. Control structure node 612 may be used to enter specific inputs related to conditional flows, such as “if, then” statements or other conditions or loops that may determine a direction of a configuration flow chart. External data source node 614 may be used to enter specific inputs related to an external data source.

Return node 614 may be used to call another configuration flow and/or return control to a current configuration flow. As such, return node 614 may be used to call another configuration flow, pass values between configuration flows and also retrieve data returned from a called configuration flow. Return node 616 helps to modularize the configuration flows such that each configuration flow may be configured to handle specific operations that focus on a particular business logic.

The API configurations generated by browser-based interface 606 may be stored in a configuration database and the generated API configurations may be retrieved by visual API engine 604 to generate source code associated with the changes and inputs provided by the user.

Specifically, visual API engine 604 interprets the API configurations for specific user inputs for each module in the application and generates the associated source code for the module. In this manner, some embodiments create a simple and intuitive visual interface and system that enables users to generate APIs that interface with database tables without having to write or learn coding.

As the user modifies the app, the source code generated by visual API engine 604 may be sent to configuration server 222. After receipt of the modifications, configuration server 222 may modify and compile the source code associated with only the changed modules in the app, independently of other modules in the app and without the requirement of compiling the source code for all modules of the app. Configuration server 222 may store the modifications on configuration database 226.

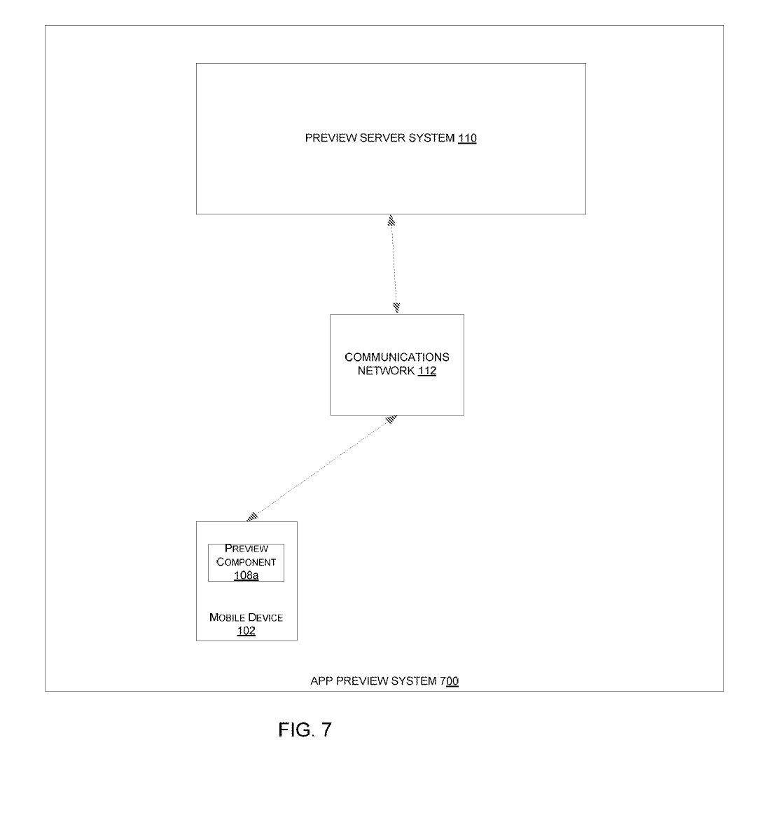

FIG. 7 is a block diagram of app preview system 700 according to an exemplary embodiment of the present invention. Unlike in app preview system 100 of FIG. 1, the present embodiment employs a single mobile device 102.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued. Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Moreover, an embodiment can be implemented as a computer-readable storage medium having computer readable code stored thereon for programming a computer (e.g., comprising a processor) to perform a method as described and claimed herein.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the above is a complete description of exemplary specific embodiments of the invention, additional embodiments are also possible. Thus, the above description should not be taken as limiting the scope of the invention, which is defined by the appended claims along with their full scope of equivalents.

1. A method comprising:
receiving, on a preview server system communicably coupled to one or more user communication devices, a first request for an application under development;
using, by the preview system, configuration data associated with the application under development to generate a device-specific executable of the application;
transmitting, by the preview server system to the user communication devices, the device-specific executable of the application;
receiving, by the preview server system, configuration changes from a first one of the user communication devices, wherein the configuration changes are associated with at least one module in the device-specific executable of the application;
updating, by the preview server system, the at least one module with the configuration changes, and regenerating the device-specific executable of the application by compiling only the at least one module in the device-specific executable of the application; and
transmitting, by the preview server system to one or more of the user communication devices, the regenerated version of the application so that changes made on a a user communication devices is reflected contemporaneously on all user communication devices wherein the application under development is running.

2. The method of claim 1, wherein the device-specific executable is native to the user communication device that requests the application under development.

3. The method of claim 1, further comprising forwarding, by a configuration server to a build server in the preview server system, the configuration data to be used in generating the device-specific executable of the application under development.

4. The method of claim 3, wherein the build server obtains source code associated with each module of the application, compiles the source code, generates the device-specific executable of the application, and sends the device-specific executable of the application to the configuration server.

5. The method of claim 1, further comprising storing configuration changes, by a configuration server in the preview server system, on a configuration database in the preview server system.

6. A preview server system comprising:
a memory;
a transceiver; and
a processor configured to perform a set of functions including:
receiving, on the preview server system communicably coupled to one or more user communication devices, a first request for an application under development;
retrieving configuration data associated with the application under development
generating with the configuration data a device-specific executable of the application;
transmitting, to the user communication devices, the device-specific executable of the application;
subsequent to the transmitting, receiving configuration changes from a first one of the user communication devices, wherein the configuration changes are associated with at least one module in the device-specific executable of the application;
updating the at least one module with the configuration changes and regenerating the device-specific executable of the application by compiling only the at least one module in the device-specific executable of the application;
receiving a second request to transmit a regenerated version of the application including the configuration changes; and
responsive to receiving the second request, transmitting, to a second one of the user communication devices, the regenerated version of the application so that changes made on the first one of the user communication devices is reflected contemporaneously on the second one of the user communication device.

7. The preview server system of claim 6, further comprising a configuration server configured to receive the first request and the second request, retrieve the configuration data, transmit the device-specific executable of the application to the user communication devices, receive the configuration changes, and transmit the regenerated version of the application under development.

8. The preview server system of claim 6, further comprising a build server configured to generate the device-specific executable of the application under development and update the at least one module with the configuration changes.

9. The preview server system of claim 6, further comprising a configuration database configured to store source code and configuration data for a plurality of applications.

10. A method comprising:
transmitting, by a first one of user communication devices to a preview server system communicably coupled to one or more user communication devices, a first request for an application under development;
receiving, from the preview server system by the first one of user communication devices, a device-specific executable of the application;
transmitting, by at least one of user communication devices to the preview server system, a second request to obtain an updated version of the application under development, the updated version including configuration changes sent from a second one of user communication devices communicatively coupled to the preview server system, wherein the configuration changes are associated with at least one module in the device-specific executable of the application and the configuration changes are used to update the at least one module, and wherein the device-specific executable of the application is regenerated by compiling only the at least one module in the device-specific executable of the application; and
receiving, from the preview server system by the first one of user communication devices, a regenerated version of the application under development, the regenerated version including configuration changes contemporaneously made on a second one of the user communication devices.

11. The method of claim 10, further comprising authenticating a user associated with user communication devices subsequent to establishing a connection with the preview server system.

12. The method of claim 10, further comprising providing a list of applications under development, wherein the first request is associated with an application selected from the list of applications.

13. The method of claim 10, further comprising generating the second request based on information obtained via a gesture capture module.

14. The method of claim 1 further comprising a visual application development system comprising:
a memory;
a transceiver; and
a processor configured to perform a set of functions including:
receiving user inputs via a plurality of nodes, one or more of which is be used to implement configuration flows to generate source code for an application under development;
generating outputs based on the user inputs received via the plurality of nodes;
generating source code for at least one module of the application under development based on the user inputs and generated outputs; and
transmitting, to a preview server system, the source code generated for the at least one module, wherein the preview server system updates the at least one module with the source code and regenerating a device-specific executable of the application by compiling only the at least one module in the device-specific executable of the application.

15. The method of claim 14 wherein the visual application development system further comprises a visual Application Programming Interface (API) server with a visual API engine, wherein the visual API engine uses user-specific configurations to generate API source code for associated modules of an application.

16. The method of claim 14 wherein the visual application development system further comprises a browser-based interface for modifying elements of an application being displayed.

17. The method of claim 16 wherein the browser-based interface includes a plurality of nodes for receiving user inputs.

18. The method of claim 17, wherein the plurality of nodes for receiving user comprises query builder node, a notification node, a control structure node, an external data source node and a return node.

19. The method of claim 17, wherein each of the plurality of nodes is configured to obtain user inputs that handle specific operations.

20. The method of claim 17, wherein each of the plurality of nodes represents specific operations in an API coding scheme and is configured to facilitate visual configuration within the browser-based interface.
